(19) United States
(12) Patent Application Publication
(10) Pub. No.: US 2005/0170828 A1
(43) Pub. Date: Aug. 4, 2005

(54) Mobile radio terminal and mobile radio terminal control method

(75) Inventors: Yousuke Nakamura, Kawasaki (JP); Toshiya Miyazaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/092,602

(22) Filed: Mar. 29, 2005

Related U.S. Application Data
(63) Continuation of application No. PCT/JP03/06716, filed on May 28, 2003.

(51) Int. Cl. H04B 7/00

(52) U.S. Cl. 455/419; 455/41.2

(57) ABSTRACT

A user having a mobile radio terminal can set operation mode for each ringing, mail reception, and call origin. This prevents forgetting of switching of operation mode. Thus, the mobile radio terminal can select the operation mode upon ringing, making a call, or transmission/reception. The mobile radio terminal includes an identification information receiver for receiving identification information produced by a short-distance radio signal from an identification information generator, a proximity evaluator for detecting the relative distance versus the identification information generator or the relative speed versus the identification information generator on the basis of the identification information received by the identification information receiver, and an operating mode changer for changing the operating mode for incoming calls, for outgoing calls, or for transmission/reception on the basis of the evaluation result of the proximity evaluator.

This is a continuation of International Application, PCT/JP2003/006716, with an international filing date of May 28, 2003.

### BACKGROUND OF THE INVENTION

The present invention relates to a mobile radio terminal and a mobile radio terminal control method, and more particularly relates to automatically selecting and controlling the operating mode for incoming calls, outgoing calls, or transmission/reception in a mobile radio terminal such as a mobile telephone or a PHS.

### BACKGROUND INFORMATION

A mobile radio terminal such as a mobile telephone or a PHS is designed such that when a call or mail comes in, the user is notified of its arrival by a predetermined ringtone. If the user forgets to turn off the power to a mobile telephone in a train, concert hall, meeting room, or the like, the ringing of the telephone can bother other people. Such telephones are therefore provided with a so-called silent mode, in which the ring volume is turned down or the ring is changed to a vibrating operation.

To set a telephone to this silent mode, the user has to press a silent mode setting button every time, and if he forgets to do this, the ringing may bother nearby people just as when the user forgets to shut off the power.

To fine-tune the operating mode during incoming calls according to where the telephone is being used, the surrounding environment, and the caller, the user has to go through several steps every time, involving pressing control buttons while looking at the displayed setting screen, and this makes the operation complicated. It is possible to envision a number of scenarios and provide control buttons so that the user can switch to each operating mode with the press of a single button, but this means that many more buttons are necessary, which can hamper efforts to keep the mobile radio terminal compact.

Japanese laid-open patent application 2000-324554 proposes a mobile radio terminal constituted such that an operating mode switching radio signal transmitted from a mobile radio terminal control unit is received, and the telephone is automatically set to silent mode, whenever the user passes through an entrance or exit that leads into or out of a specific area.

### SUMMARY OF THE INVENTION

The mobile radio terminal according to a first aspect of the present invention is a mobile radio terminal that allows operating modes to be selected for incoming calls, for outgoing calls, or for transmission/reception, comprising an identification information receiver for receiving identification information produced by a short-distance radio signal from an identification information generator, a proximity evaluator for detecting the relative distance versus the identification information generator or the relative speed versus the identification information generator on the basis of the identification information received by the identification information receiver, and an operating mode changer for changing the operating mode for incoming calls, for outgoing calls, or for transmission/reception on the basis of the evaluation result of the proximity evaluator.

Here, if an identification information generator equipped with identification information such as an RFID (Radio Frequency IDentification) tag is attached to a garment or the like, the relative distance or relative speed between the identification information generator and the mobile radio terminal can be detected as the mobile radio terminal moves, or the setting can be such that the operating mode of the mobile radio terminal is changed when the mobile radio terminal is taken out of or put into a pocket of a garment.

The mobile radio terminal according to a second aspect of the present invention is the mobile radio terminal according the first aspect, wherein the operating mode changer comprises an operating mode management database for keeping the operating mode corresponding to the relative distance or relative speed versus the identification information generator, an operating mode selector for selecting an operating mode from the operating mode management database on the basis of the relative distance or relative speed versus the identification information generator detected by the proximity evaluator, and an operating mode setter for setting the operating mode for incoming calls, for outgoing calls, or for transmission/reception according to the operating mode selected by the operating mode selector.

Here, the condition settings held in the operating mode management database are suitably set according to the user's preferences, which allow the operating mode to be fine-tuned for incoming calls, incoming mail, or call origin according to the proximity of the mobile radio terminal to the identification information generator.

The mobile radio terminal according to a third aspect of the present invention is the mobile radio terminal according to the second aspect, wherein the operating mode changer further comprises a mode change notifier for notifying the user of the selected operating mode when the operating mode selected by the operating mode selector is different from the currently set operating mode.

Here, the user is notified that the operating mode has been changed, which allows the user to confirm a mode change.

The mobile radio terminal according to a fourth aspect of the present invention is the mobile radio terminal according to the third aspect, wherein the operating mode changer further comprises a confirmation acceptor for accepting a confirmation command from the user when the user is notified by the mode change notifier of the selected operating mode, and the operating mode setter sets the operating mode selected by the operating mode selector when there is a confirmation command from the confirmation acceptor.

The constitution here is such that when there is a notification of a mode change, the mode change is performed only when the user has confirmed and approved the change and the malfunction can be prevented.

The mobile radio terminal control system according to a fifth aspect of the present invention is a mobile radio terminal control system comprising an identification information generator for generating identification information by means of a short-distance radio signal, an identification information receiver for receiving identification information produced by a short-distance radio signal from the identification information generator, a proximity evaluator for detecting the relative distance between the identification information generator and the mobile radio terminal or the relative speed between the identification information generator and the mobile radio terminal on the basis of the identification information received by the identification information receiver, and an operating mode changer for changing the operating mode of the mobile radio terminal for incoming calls, for outgoing calls, or for transmission/reception on the basis of the evaluation result of the proximity evaluator.

Here, the present invention provides a mobile radio terminal control system that includes an identification information generator for transmitting identification information to a mobile radio terminal, which allows the operating mode of the mobile radio terminal to be changed according to the proximity of the mobile radio terminal to this identification information generator.

The mobile radio terminal control method according to a sixth aspect of the present invention is a method for controlling a mobile radio terminal that allows operating modes to be selected for incoming calls, for outgoing calls, or for transmission/reception, comprising the stages of receiving identification information produced by a short-distance radio signal from an identification information generator, detecting the relative distance between the identification information generator and the mobile radio terminal or the relative speed between the identification information generator and the mobile radio terminal on the basis of the received identification information, and changing the operating mode for incoming calls, for outgoing calls, or for transmission/reception on the basis of the detected relative distance or relative speed.

Here, a mobile radio terminal control system is constituted so as to employ a method in which the operating mode of a mobile radio terminal is changed according to the proximity of the mobile radio terminal to an identification information generator.

The program according to a seventh aspect of the present invention is a program for executing on a computer a method for controlling a mobile radio terminal that allows operating modes to be selected for incoming calls, for outgoing calls, or for transmission/reception, comprising the steps of receiving identification information produced by a short-distance radio signal from an identification information generator, detecting the relative distance between the identification information generator and the mobile radio terminal or the relative speed between the identification information generator and the mobile radio terminal on the basis of the received identification information, and changing the operating mode for incoming calls, for outgoing calls, or for transmission/reception on the basis of the detected relative distance or relative speed.

Here, when this program installed on a mobile radio terminal is executed, operating mode control can be executed according to the proximity of the mobile radio terminal to an identification information generator.

### BRIEF DESCRIPTION OF THE DRAWINGS

Referring to the attached drawings which form a part of this original disclosure:

FIG. 1 is a control block diagram illustrating the main constitution of a mobile radio terminal in which an embodiment of the present invention is employed;

FIG. 2 is a function block diagram of a mobile radio terminal;

FIG. 3 is a diagram illustrating how the mobile radio terminal in a working example is used;

FIG. 4 is a control flowchart for a mobile radio terminal; and

FIG. 5 is a table of operating conditions.

### DETAILED DESCRIPTION OF THE PREFERRED EMBODIMENTS

With the mobile radio terminal discussed in Japanese laid-open patent application 2000-324554, a mobile radio terminal control unit that transmits radio signals for switching the operating mode must be installed at specific places. Therefore, a problem with this approach is that the use of the mobile radio terminal cannot select the areas where the operating mode is to be switched. It is also impossible to fine-tune the operating mode for incoming calls and mail or call origin.

It is an object of the present invention to allow a user who is the owner of a mobile radio terminal to fine-tune the operating mode for incoming calls, incoming mail, and call origin, and to prevent the user from forgetting to switch the operating mode.

Summarized Constitution

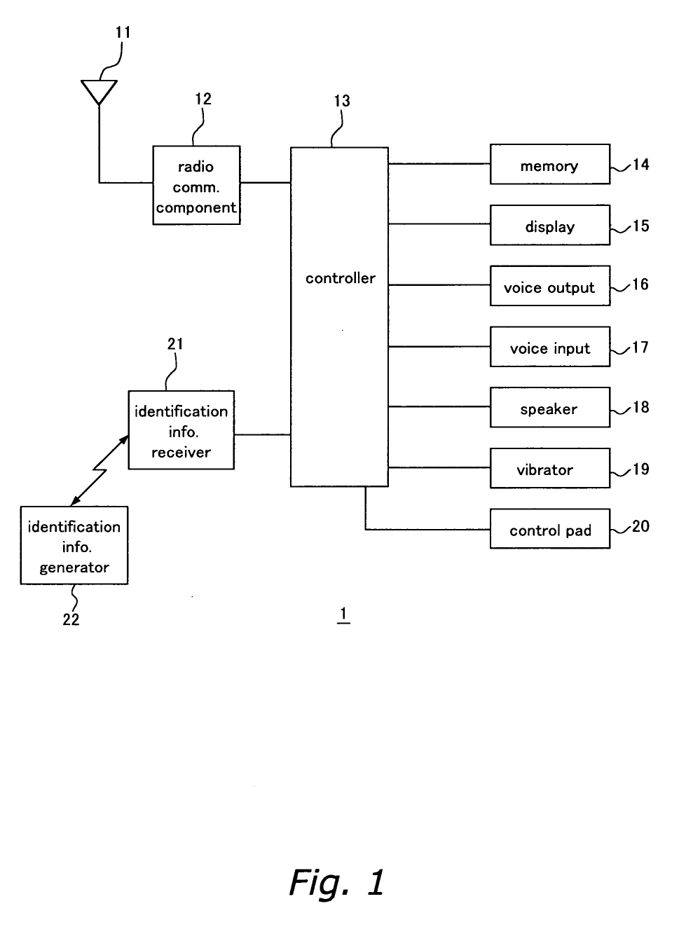

The summarized constitution of a mobile radio terminal in which an embodiment of the present invention is employed will be described through reference to FIG. 1. The mobile radio terminal of the present invention assumes a telephone terminal that is used with a mobile communications system, such as a mobile telephone or a PHS, equipped with a wireless talking function, a mail sending and receiving function, a web access function, and so forth.

As shown in FIG. 1, a mobile radio terminal 1 comprises an antenna 11 for receiving radio waves sent out from the base station of a mobile communications system and for transmitting radio waves to the base station of the caller or the party transmitting data; a radio communication component 12 for modulating and demodulating the radio waves sent and received by the antenna 11; a controller 13 for controlling the various components; a memory 14 for storing various parameters and data, application software, and so forth; a display 15 constituted by a liquid crystal display panel or the like for displaying image data and so forth; a voice output 16 for outputting the voice of the other party during conversation; an voice input 17 for collecting the sound of the user's voice; a speaker 18 for outputting a ringtone; a vibrator 19 for performing a vibrating operation when a call comes in; a control pad 20 made up of a plurality of keys for inputting telephone numbers when making a call, inputting mail messages, inputting various settings, etc.; and so forth.

The mobile radio terminal 1 also comprises an identification information receiver 21 for receiving identification information transmitted from an identification information generator 22. The identification information generator 22 here can be constituted by an RFID tag equipped with a chip capable of reading and writing identification information in a non-contact manner, and the identification information receiver 21 can be constituted by an RFID reader that reads identification information recorded to this RFID tag by non-contact electrical power transmission. It is assumed that the user has mounted the identification information generator 22 constituted by the RFID tag on a garment or other article, and the configuration is such that identification information stored in the identification information generator 22 is acquired by the identification information receiver 21. The distance at which the RFID reader can read identification information stored in the RFID tag is approximately 70 cm or less, but the identification information generator 22 of the present invention is assumed to make use of short-distance radio such as that when an RFID tag is used.

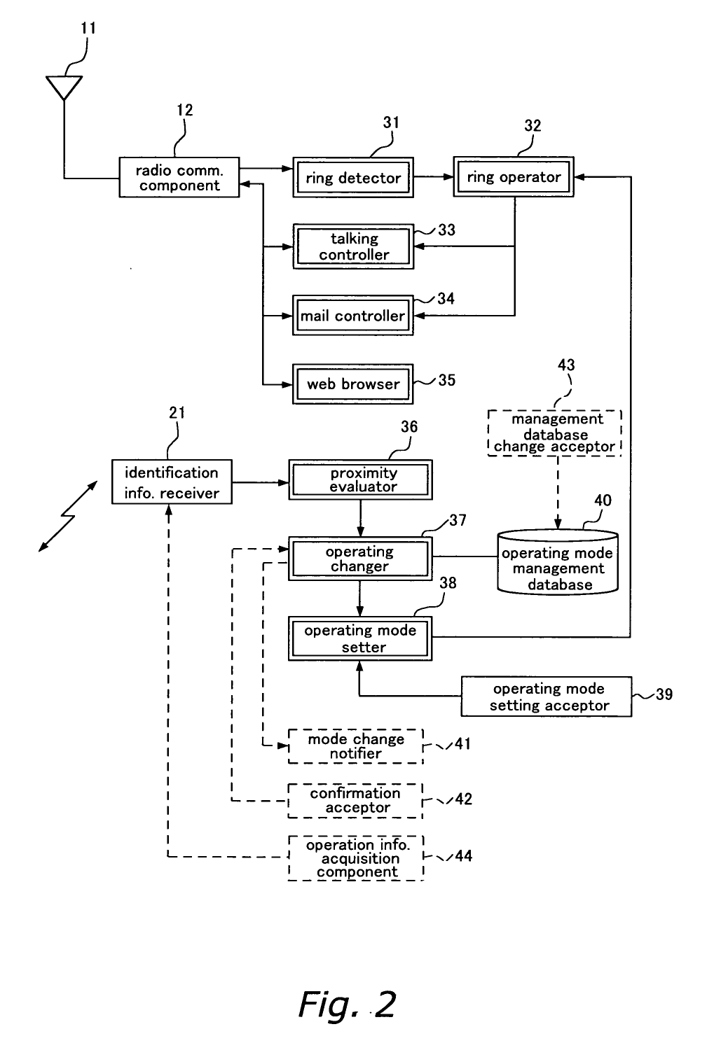

The controller 13 comprises a microprocessor including a CPU, ROM, RAM, and various kinds of interface, and performs various functions along with hardware by executing an application. The main functions performed by the controller 13 will be described through reference to the function block diagram shown in FIG. 2.

The function components here comprise a ring detector 31 for detecting whether or not the local terminal is being called from radio waves demodulated by the radio communication component 12 via the antenna 11; a ring operator 32 for determining whether a call to the local terminal detected by the ring detector 31 is a telephone call or incoming mail, and controlling the ring operation on the basis of a ringtone or vibration pattern set for each call origin; a talking controller 33 for controlling voice data during an incoming or outgoing telephone call; a mail controller 34 for performing transmission/reception control of image data and character string data when there is incoming or outgoing mail; a web browser 35 for receiving image data and character string data during Web access, controlling the display of this data on the display 15, accepting transmission data from the user, and thereby controlling data transmission; a proximity evaluator 36 for evaluating proximity on the basis of the identification information of the identification information generator 22 received by the identification information receiver 21; an operating mode management database 40 for storing operating modes set on the basis of the relative distance or relative speed versus the identification information generator 22; an operating mode changer 37 for changing the mode by selecting a suitable operating mode through reference to the operating mode management database 40 on the basis of the evaluation result of the proximity evaluator 36; an operating mode setting acceptor 39 for accepting an operating mode change from the user; an operating mode setter 38 for setting a change to the current operating mode when there is an operating mode setting request from the user via the operating mode setting acceptor 39, or when there is an operating mode change request to the operating mode changer 37; and so forth.

Radio waves received through the antenna 11 are demodulated by the radio communication component 12 and sent to the ring detector 31. If it is determined by the ring detector 31 that there is a call to the local terminal, a ringtone or vibration pattern is outputted via the speaker 18 or the vibrator 19, corresponding to an incoming telephone call, incoming mail, or call origin on the basis of the operating mode set at the operating mode setter 38.

If the call is due to an incoming telephone call, control is shifted to the talking controller 33, and when the user begins talking, the received voice data is outputted via the voice output 16, and the voice of the user is collected through the voice input 17 and sent out as voice data. When the user uses the control pad 20 to input the telephone number of another party, the talking controller 33 calls the inputted telephone number, and when the other party answers, voice data transmission/reception control is performed in the same way.

When there is incoming mail, control is shifted to the mail controller 34, and the received character string data or image data is stored in the memory 14 and displayed on the display 15 according to the request of the user. When the user uses the control pad 20 to input a mail message and, if necessary, indicates that the mail will be sent with attached image data, the mail controller 34 performs processing for mail transmission, including character string data and image data, to the mail address of the designated recipient.

The web browser 35 accesses the URL designated by the user, receives the corresponding character string data or image data, and displays this data on the display 15.

The operating mode management database 40 stores operating modes related to ring operation for every call origin when there is an incoming call or incoming mail according to the proximity of the local terminal to the identification information generator 22. An operating mode table that assigns operating modes to operating conditions stored in this operating mode management database 40 can be prepared ahead of time to contain default operating mode patterns, or the configuration can be such that changes inputted by the user through the control pad 20 are accepted by a management database change acceptor 43, and the contents of the operating mode management database 40 are changed. Also, the operating mode management database 40 can be constructed within the memory 14 of the local terminal, or it can be provided to an external server that can be connected on a network.

The proximity evaluator 36 acquires a proximity based on the relative distance or relative speed between the local terminal and the identification information generator 22 on the basis of identification information received by the identification information receiver 21.

When identification information is received by non-contact electrical power transmission from the identification information receiver 21 to the identification information generator 22, the attenuation of the response pulse increases in proportion to the distance between the identification information generator 22 and the mobile radio terminal 1, so the amplitude of the response pulse decreases with respect to a pulse during transmission. Accordingly, the constitution can be such that when the amplitude of the response pulse is greater than a preset value, the proximity evaluator 36 determines that the relative distance between the mobile radio terminal 1 and the identification information generator 22 is small, but when the amplitude of the response pulse is less than a preset value, the proximity evaluator 36 determines that the relative distance between the mobile radio terminal 1 and the identification information generator 22 is large.

Also, when identification information is received by non-contact electrical power transmission from the identification information receiver 21 to the identification information generator 22, it is possible to determine whether the mobile radio terminal 1 is moving closer to or farther away from the identification information generator 22 on the basis of the frequency change of the response pulse. When the mobile radio terminal 1 is moving with respect to the identification information generator 22, the transmission/reception pulses are subjected to the Doppler effect, and the frequency of the response pulse becomes lower while the relative distance is increasing (when the two are moving farther apart), whereas the frequency of the response pulse becomes higher while the relative distance is decreasing (when the two are moving closer together). Because of this, the proximity evaluator 36 is able to determine whether the identification information generator 22 and the mobile radio terminal 1 are moving closer together or farther apart by determining whether the frequency of the response pulse is lower or higher than the frequency of the transmission pulse.

The operating mode changer 37 refers to the operating mode management database 40 and selects the operating mode corresponding to the current relative distance or relative speed between the mobile radio terminal 1 and the identification information generator 22, on the basis of the evaluation result of the proximity evaluator 36.

The operating mode setter 38 sets the ringtone, vibration pattern, etc., during an incoming call on the basis of the operating mode selected with the operating mode changer 37.

The role of the operating mode setting acceptor 39 is to accept manual commands for a change in operating mode from the user. For instance, information indicating operation of the silent mode button, which is used to switch between a predetermined silent mode and the normal incoming call mode, is transmitted to the operating mode setter 38.

It is also possible for the configuration to be such that when the operating mode changer 37 changes the current operating mode on the basis of the evaluation result of the proximity evaluator 36, the user is notified of a change in operating mode. In this case, a mode change notifier 41 can be provided so as to notify the user that the operating mode is being changed.

When the operating mode changer 37 selects an operating mode that is different from the current operating mode, the operating mode changer 37 sends the mode change notifier 41 a change notification request signal for notifying of a change in operating mode. The mode change notifier 41 performs mode change notification, for example, by outputting a character string display to the display 15, outputting a notification sound through the speaker 18, or flashing an LED, on the basis of this change notification request signal.

It is also possible for the constitution to be such that the mode change notifier 41 notifies the user of a mode change, and the mode change is only executed if the user approves the change. In this case, a confirmation acceptor 42 can be provided for accepting a confirmation indication from the user, and sending a confirmation indication signal to the operating mode changer 37. The operating mode changer 37 can be constituted so as to send a change notification request to the mode change notifier 41, wait for a notification indication signal from the confirmation acceptor 42, and send a request for an operating mode change to the operating mode setter 38.

It is also possible for the constitution to be such that the identification information held in the identification information generator 22 is acquired by the identification information receiver 21 only when the user has performed some kind of operation. For instance, an operation information acquisition component 44 is provided for acquiring user operation information, such as information indicating that the user has operated a button or the like provided to the outer surface or a key provided to the control pad 20, that a collapsible mobile terminal has been opened, or that the antenna has been extended, and the acquisition and processing of identification information by the identification information receiver 21 is commenced when this operation information acquisition component 44 detects an operation by the user.

### FIRST EMBODIMENT

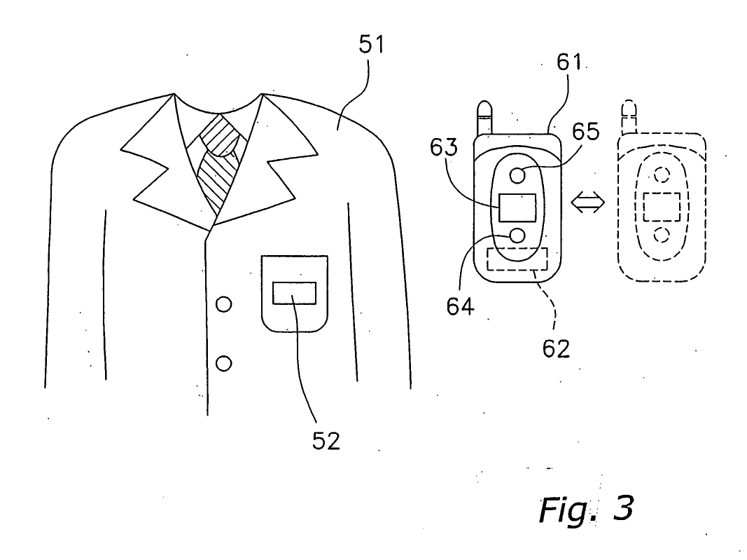

The identification information generator 22 can utilize an RFID (Radio Frequency IDentification) tag with an embedded antenna and a storage medium featuring a non-contact IC chip. As shown in FIG. 3, a safety pin, clip, or other attached device is provided to an RFID tag 52 consisting of a storage medium and an antenna embedded in a plastic plate, and the attachment device is used to attach to a specific location on the user's clothing (the outer surface of a chest pocket here).

The mobile radio terminal 1 here is assumed to be a mobile radio terminal 61 equipped with an RFID reader 62 capable of reading identification information recorded to the RFID tag 52. If the constitution is such that the identification information stored in the RFID tag 52 will be written from the mobile radio terminal 61 side, then an RFID reader/writer is used instead of the RFID reader 62.

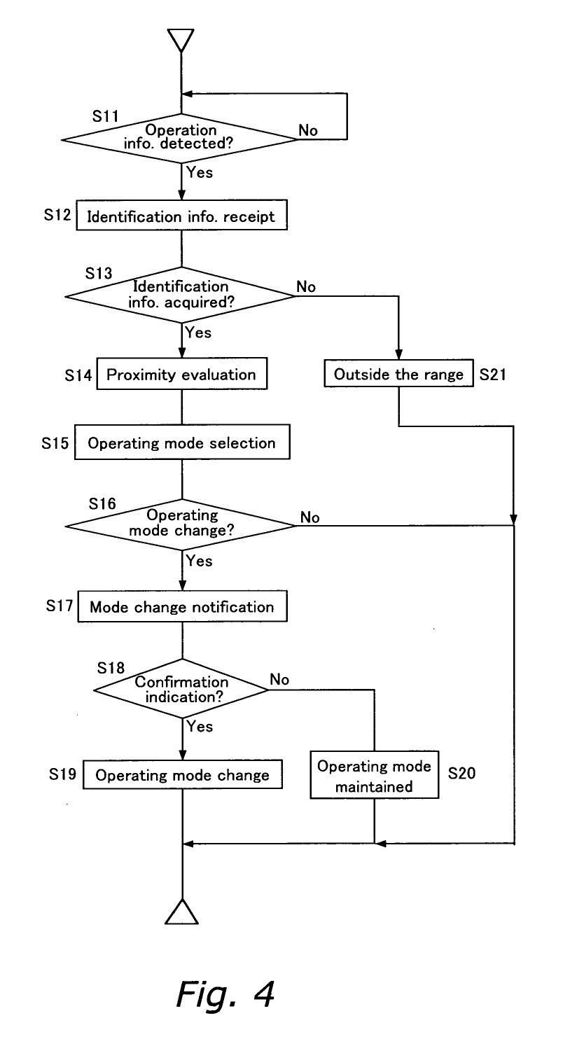

The operating mode control of this mobile radio terminal 61 will be described on the basis of the control flowchart in FIG. 4.

In step S11, it is determined whether or not identification information has been detected. The operation information acquisition component 44 detects identification information when the user has performed some kind of operation, as when the user has pressed a key on the mobile radio terminal 61, when a collapsible mobile radio terminal has been opened, or when the antenna has been extended. The flow moves to step S12 when identification information has been acquired by the operation information acquisition component 44.

In step S12, the reception processing of identification information held in the RFID tag 52 is commenced. Here, the RFID reader 62 performs non-contact electrical power transmission on the RFID tag 52, and identification information sent from the RFID tag 52 is received.

In step S13, it is determined whether or not identification information sent from the RFID tag 52 has been received. If identification information has been received from the RFID tag 52, the flow moves to step S14, but if no identification information has been acquired from the RFID tag 52 after a specific time has elapsed, the flow moves to step S21.

In step S21, processing is performed for when the relative distance between the mobile radio terminal 61 and the RFID tag 52 is determined to be sufficiently great to be outside the range. For instance, the constitution can be such that if the mobile radio terminal 61 has been operated even though it is located at a place far away from the RFID tag 52 attached to the user's clothing, it is determined that the mobile radio terminal 61 was used without permission, and the functions of the mobile radio terminal 61 are locked.

In step S14, the proximity between the mobile radio terminal 61 and the RFID tag 52 is determined on the basis of the acquired identification information. The proximity evaluator 36 compares the amplitude of the transmission pulse from the RFID reader 62 with the amplitude of the response pulse received by the RFID reader 62, and determines how great the distance is between the mobile radio terminal 61 and the RFID tag 52 on the basis of the amount of attenuation, and this result can serve as proximity information. Also, the proximity evaluator 36 compares the frequency of the transmission pulse from the RFID reader 62 with the frequency of the response pulse received by the RFID reader 62, and determines on the basis of the change in frequency whether the mobile radio terminal 61 and the RFID tag 52 are moving closer together or farther apart, and this result can serve as proximity information.

In step S15, the operating mode changer 37 refers to the data stored in the operating mode management database 40 and selects an operating mode on the basis of the evaluation result of the proximity evaluator 36.

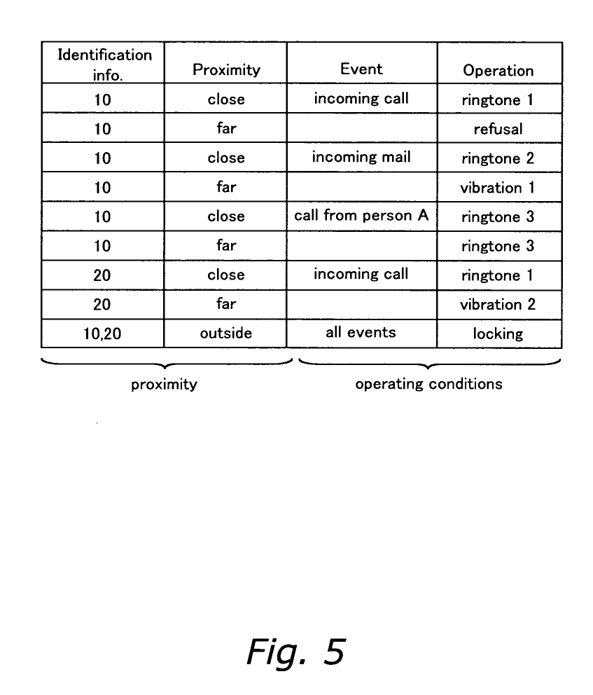

FIG. 5 shows an example of a table of correspondence between operating mode and proximity data stored in the operating mode management database 40.

In FIG. 5, identification information of “10” is set in one RFID tag and “20” in another, and an operating mode corresponding to the proximity between the mobile radio terminal 61 and each RFID tag is set for every event. For instance, when it is determined that the mobile radio terminal 61 is moving closer to the first RFID tag “10,” the terminal is set to ring “ringtone 1” for an incoming call. Conversely, when it is determined that the mobile radio terminal 61 is moving away from the first RFID tag “10,” the terminal is set to refuse incoming calls. Similarly, the ringtone settings for incoming mail are set according to the proximity between the mobile radio terminal 61 and the first RFID tag “10.” Other different ringtones can be set for specific call origins. In the case of FIG. 5, the terminal is set to ring “ringtone 3” when a call comes in from “person A,” regardless of the distance between the first RFID tag “10” and the mobile radio terminal 61. Also, when the second RFID tag “20” is attached at a different location from that of the first RFID tag “10,” as shown in FIG. 5, the operating mode is set according to the proximity between the mobile radio terminal 61 and the second RFID tag “20.” It is also possible to dispose three or more RFID tags having different identification information, in which case the operating mode can be set according to the proximity of each to the mobile radio terminal 61. Also, the constitution can be such that when the identification information of all the RFID tags owned by the user cannot be read, all the functions of the mobile radio terminal 61 are locked, as mentioned in the description of step S21. As shown in FIG. 5, the settings can be such that all functions are locked in the event that no identification information is obtained from either the first RFID tag “10” or the second RFID tag “20” (when three or more RFID tags are used, they can also be included in this).

In step S16, it is determined whether or not the operating mode selected at the operating mode changer 37 is different from the current operating mode. The flow moves to step S17 when the operating mode is different from the currently set operating mode.

In step S117, the user is notified of a change in operating mode. In this case, the operating mode changer 37 sends a change notification request to the mode change notifier 41 and notifies the user of the change via the display 15, the speaker 18, the vibrator 19, etc., of the mobile radio terminal 61. For instance, as shown in FIG. 3, if a liquid crystal panel 63 for supplementary display is provided to the outside of the mobile radio terminal 61, the constitution can be such that this liquid crystal panel 63 displays that “the operating mode is being changed.” If an LED 64 is provided to the outside of the mobile radio terminal 61, this LED 64 can be flashed to notify of a change in operating mode. Notification of a change in operating mode can also be accomplished by sounding a buzzer through the speaker 18 to notify of a change in operating mode, or the vibrator 19 can be actuated, or a combination of these operations can be employed.

In step S118, it is determined whether or not there is a confirmation indication from the user with respect to an operating mode change notification. It is also possible for the operating mode selected with the operating mode changer 37 to be automatically changed after operating mode change notification has been performed, and the constitution can be such that the operating mode is only changed after performing mode change notification and waiting for a confirmation indication from the user. In this case, for instance, it is possible to determine that there was a confirmation indication from the user when a button 65 provided to the outside of the mobile radio terminal 61 has been pressed. FIG. 3 shows the button 65 disposed on the front of the mobile radio terminal 61, but this button can also be provided on the side or back, and it is also possible to have one of the control keys provided to the control pad 20 serve two functions.

In step S18, if it is determined that there was a confirmation indication from the user, the flow moves to step S19. In step S19, the operating mode is changed to the mode selected by the operating mode changer 37. The operating mode is updated when there is an incoming call set by the operating mode setter 38.

In step S20, the operating mode selected by the operating mode changer 37 is rejected, and the currently set operating mode is maintained.

With a constitution such as this, the RFID tag 52 is attached to a garment 51, and it is detected that the user has taken the mobile radio terminal 61 out of a pocket or put it into a pocket on the basis of the proximity of the RFID tag 52 to the mobile radio terminal 61, allowing the operating mode to be changed. Since the proximity of the RFID tag 52 to the mobile radio terminal 61 can be detected automatically, the user does not need to worry about forgetting to change the operating mode.

Also, mistaken operation due to erroneous detection of the proximity can be prevented in the event that the operating mode is changed after operating mode change notification has been performed and a confirmation indication has been obtained from the user.

### OTHER EMBODIMENTS

As long as the RFID tag has an embedded antenna and a storage medium featuring a non-contact IC chip, it can be used in a variety of configurations. For instance, a constitution is possible in which the RFID tag can be mounted to the cap of a ballpoint pen owned by the user. Also, if the owner is required to wear a name tag or ID card on company premises, it is possible to embed the RFID tag in this name tag or ID card.

With a mobile radio terminal capable of emitting a button confirmation sound every time the keys on the control pad 20 are pressed, it is possible to switch this button confirmation sound on and off according to the distance from the RFID tag. Similarly, if the terminal is capable of emitting and opening/closing sound through the speaker 18 when a collapsible mobile radio terminal is opened or closed, this opening/closing sound can be switched on and off according to the distance from the RFID tag. Furthermore, when the terminal is capable of emitting an sending confirmation sound through the speaker 18 when mail is sent, a constitution is possible in which this sending confirmation sound is switched on and off according to the distance from the RFID tag.

Also, a constitution is possible in which the incoming call sound, button confirmation sound, or other sounds outputted through the speaker 18 are not only switched on and off according to the distance from the RFID tag, but are also controlled for volume. Similarly, with a mobile radio terminal capable of speakerphone talking, in which the voice of the other party is outputted through the speaker 18, a constitution is possible in which the volume is adjusted according to the distance from the RFID tag.

### INDUSTRIAL APPLICABILITY

With the present invention, it is possible to set an operating mode based on the proximity between a mobile radio terminal and an identification information generator, which eliminates the problem of forgetting to change the mode, and the resulting inconvenience to other people, when the user enters a place where the operating mode of mobile radio terminals is restricted, such as in meeting rooms and trains, theaters, and other such public facilities.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

1. A mobile radio terminal that allows operating modes to be selected for incoming calls, for outgoing calls, or for transmission/reception, comprising:
an identification information receiver for receiving identification information produced by a short-distance radio signal from an identification information generator;
a proximity evaluator for detecting the relative distance versus the identification information generator or the relative speed versus the identification information generator on the basis of the identification information received by the identification information receiver; and
an operating mode changer for changing the operating mode for incoming calls, for outgoing calls, or for transmission/reception on the basis of the evaluation result of the proximity evaluator.

2. The mobile radio terminal according to claim 1, wherein the operating mode changer comprises:
an operating mode management database for keeping the operating mode corresponding to the relative distance or relative speed versus the identification information generator;
an operating mode selector for selecting an operating mode from the operating mode management database on the basis of the relative distance or relative speed versus the identification information generator detected by the proximity evaluator; and
an operating mode setter for setting the operating mode for incoming calls, for outgoing calls, or for transmission/reception according to the operating mode selected by the operating mode selector.

3. The mobile radio terminal according to claim 2, wherein the operating mode changer further comprises a mode change notifier for notifying the user of the selected operating mode when the operating mode selected by the operating mode selector is different from the currently set operating mode.

4. The mobile radio terminal according to claim 3, wherein the operating mode changer further comprises a confirmation acceptor for accepting a confirmation command from the user when the user is notified by the mode change notifier of the selected operating mode, and the operating mode setter sets the operating mode selected by the operating mode selector when there is a confirmation command from the confirmation acceptor.

5. A mobile radio terminal control system, comprising:
an identification information generator for generating identification information by means of a short-distance radio signal;
an identification information receiver for receiving identification information produced by a short-distance radio signal from the identification information generator;
a proximity evaluator for detecting the relative distance between the identification information generator and the mobile radio terminal or the relative speed between the identification information generator and the mobile radio terminal on the basis of the identification information received by the identification information receiver; and
an operating mode changer for changing the operating mode of the mobile radio terminal for incoming calls, for outgoing calls, or for transmission/reception on the basis of the evaluation result of the proximity evaluator.

6. A method for controlling a mobile radio terminal that allows operating modes to be selected for incoming calls, for outgoing calls, or for transmission/reception, comprising the steps of:
receiving identification information produced by a short-distance radio signal from an identification information generator;
detecting the relative distance between the identification information generator and the mobile radio terminal or the relative speed between the identification information generator and the mobile radio terminal on the basis of the received identification information; and
changing the operating mode for incoming calls, for outgoing calls, or for transmission/reception on the basis of the detected relative distance or relative speed.

7. A computer-readable recording medium on which is recorded a program for executing on a computer a method for controlling a mobile radio terminal that allows operating modes to be selected for incoming calls, for outgoing calls, or for transmission/reception, comprising the steps of:
receiving identification information produced by a short-distance radio signal from an identification information generator;
detecting the relative distance between the identification information generator and the mobile radio terminal or the relative speed between the identification information generator and the mobile radio terminal on the basis of the received identification information; and
changing the operating mode for incoming calls, for outgoing calls, or for transmission/reception on the basis of the detected relative distance or relative speed.
